(19) United States
(12) Patent Application Publication
(10) Pub. No.: US 2022/0105425 A1
(43) Pub. Date: Apr. 7, 2022

(54) FORTUNE TELLING DEVICE AND SYSTEM INCLUDING TOUTING SERVICE, BETTING SERVICE AND METHOD OF USING THE SAME

(71) Applicant: Geno Munari, Las Vegas, NV (US)

(72) Inventor: Geno Munari, Las Vegas, NV (US)

(21) Appl. No.: 17/065,410

(22) Filed: Oct. 7, 2020

(51) Int. Cl. A63F 9/18; G07F 17/32; G07F 17/42; G06Q 50/34

(52) U.S. Cl. CPC A63F 9/181; G07F 17/3288; G06Q 50/34; G07F 17/42; G07F 17/3251

(57) ABSTRACT

A fortune telling device provides touting services. The fortune telling device is linked to remote touting services and uses the information to make sporting event outcome predictions. The fortune telling device may include an interface for allowing users to place sports bets and sign up for an account with a third-party sportsbook.

### FIELD OF THE INVENTION

The embodiments of the present invention relate to a fortune telling device and system configured to interact with a user via celebrity personalities.

### BACKGROUND

Fortune telling is a well-known and well-liked entertainment endeavor. While most people understand that fortune telling is not real, most people still enjoy fortune telling as an entertainment premise. Live fortune telling is available but tends to be more than most people want from the experience. Heretofore, electronic, automated fortune telling devices have been lacking.

Accordingly, it would be beneficial to develop an electronic, automated fortune telling devices and systems which are exciting and attractive to users.

### SUMMARY

The embodiments of the present invention are directed to an electronic, automated fortune telling device utilizing celebrity personalities to entertain users. In one embodiment, a portable standalone unit including a cabinet housing a video display, bill validator, debit/credit card reader, user interface, processor, printer, memory and speakers. The memory maintains one or more databases of celebrity video and audio clips which are used to present the fortune telling routines to the user via the video display. In one embodiment, a user is able to select a celebrity to present the fortune telling routine. In another embodiment, the celebrity presenting the fortune telling routine is randomly selected by the processor.

In another embodiment, the fortune telling device includes a printer for printing out fortunes or other information. For example, one embodiment of the device, a displayed celebrity conducts a mock wedding after which the fortune telling device prints a wedding certificate. In such an embodiment, the fortune telling device may include a storage compartment and dispenser for dispensing a pair of wedding bands for the users being fictitiously wed.

In another embodiment, the fortune telling routine is triggered when a sensor determines that a user is staring into the eyes of the celebrity personality. The sensor may be positioned proximate the video display to capture movements of a potential user such that pre-recorded attraction video and audio files may be played. In one embodiment, the sensor, along with video recognition software, can identify certain attributes of the user and quasi-customize the fortune telling routine by selecting specific fortune telling routines from a database of fortune telling routines.

In another embodiment, the fortune telling device provides touting services. In one such embodiment, the fortune telling device is linked to remote touting services and uses the information to make predictions. In another embodiment, the fortune telling device includes an interface for allowing users to place sports bets.

Other variations, embodiments and features of the present invention will become evident from the following detailed description, drawings and claims.

### BRIEF DESCRIPTION OF THE DRAWINGS

FIG. 1 illustrates a front view of a first exemplary fortune telling device according to the embodiments of the present invention;

FIG. 2 illustrates a block diagram of a fortune telling device according to the embodiments of the present invention;

FIG. 3 illustrates a flow chart detailing one method of operating the fortune telling device according to the embodiments of the present invention;

FIGS. 4A-4D illustrate a series of exemplary screen shots associated with one method of operating the fortune telling device according to the embodiments of the present invention;

FIG. 5 illustrates a block diagram of a fortune telling device which can act as a mock wedding chapel according to the embodiments of the present invention;

FIG. 6 illustrates a flow chart detailing another method of operating the fortune telling device according to the embodiments of the present invention;

FIGS. 7A-7H illustrate a series of exemplary screen shots associated with another method of operating the fortune telling device according to the embodiments of the present invention;

FIG. 8 illustrates a mechanism for dispensing mock wedding rings according to the embodiments of the present invention;

FIGS. 9A and 9B illustrates a fortune telling device incorporating a camera according to the embodiments of the present invention;

FIG. 10 illustrates a network comprising multiple fortune telling devices in communication with a central data server according to the embodiments of the present invention;

FIG. 11 illustrates a block diagram of another embodiment of a fortune telling device further equipped with touting services according to the embodiments of the present invention;

FIG. 12 illustrates a flow chart detailing another method of operating the fortune telling device equipped with touting services according to the embodiments of the present invention;

FIGS. 13A-13F illustrate screen shots of a fortune telling device equipped with touting services according to the embodiments of the present invention; and

FIGS. 14A-14G illustrate screen shots of a fortune telling device equipped with a betting interface according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a stand-alone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks. As used herein, a “terminal” should be understood to be any one of a general purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

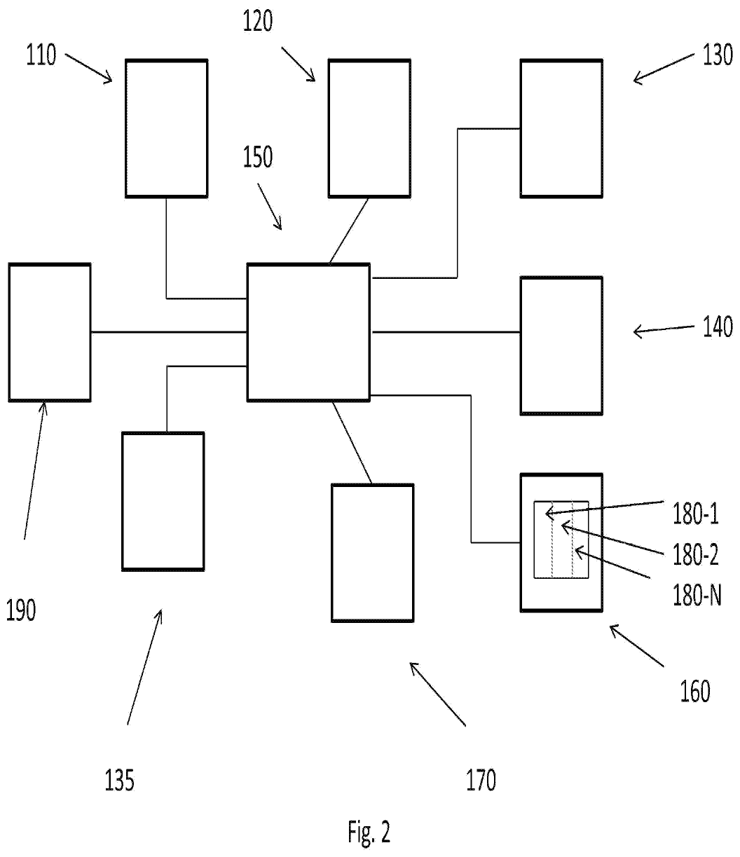

FIG. 2 shows a block diagram of a fortune telling device 100 according to the embodiments of the present invention. The fortune telling device 100 includes a video display 110, bill validator 120, debit/credit card reader 130, printer 135, user interface 140, processor 150, memory 160 and speakers 170. In one embodiment, the user interface 140 is a touch screen video display while in other embodiments the user interface may be a button panel, joystick, track ball or similar article. The memory 160 manages one or more databases 180-1 through 180-N. The one or more databases 180-1 through 180-N store celebrity video and audio files for reasons set forth below. The one or more databases 180-1 through 180-N may also store various music files, attract mode files and other video and audio files as set forth below. In one embodiment, a sensor 190 is positioned to capture a user's eyes or other movements which are used to trigger the fortune telling routine comprising a video and audio file.

As configured, the processor 150 is programmed with executable instructions to communicate with and/or manage and/or control the video display 110, bill validator 120, debit/credit card reader 130, user interface 140, speakers 170 and sensor 190 contained in housing 195.

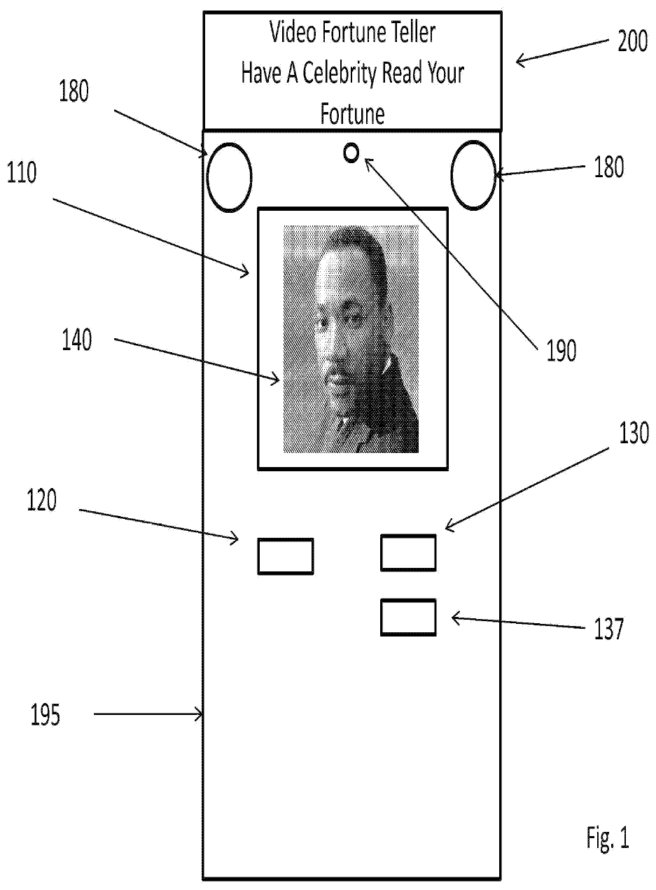

FIG. 1 shows a front view of an exemplary fortune telling device 100 according to the embodiments of the present invention. The fortune telling device 100 includes the video display 110, bill validator 120, debit/card reader 130, user interface 140 (in this case a touch screen display), speakers 170 and sensor 190. A sign 200 is designed to attract users. Printer slot 137 in communication with the printer 135 discharges a printed keepsake memorializing the fortune telling experience.

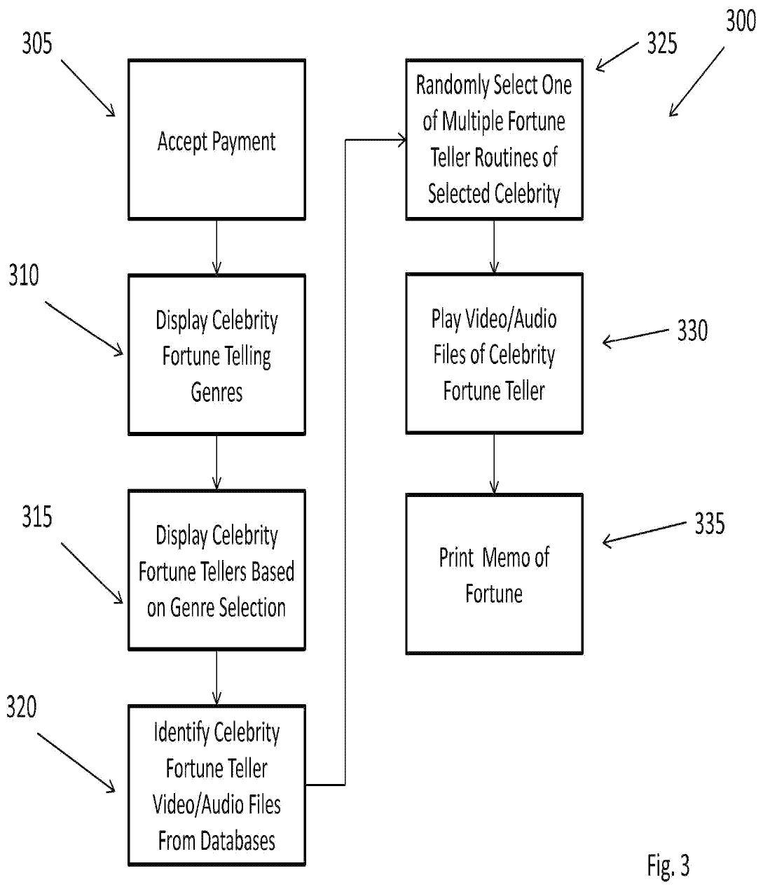

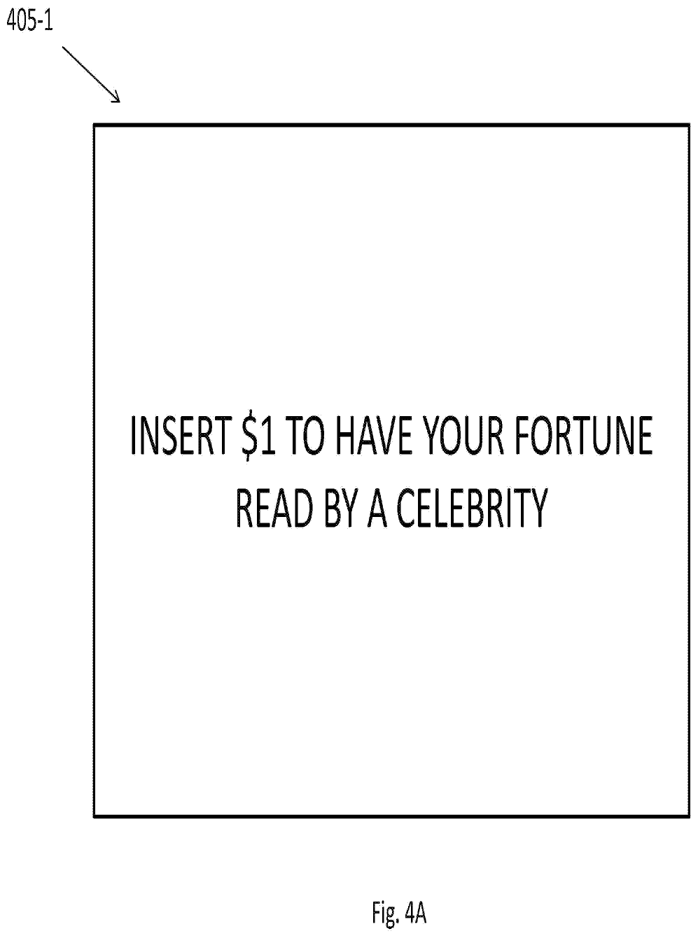

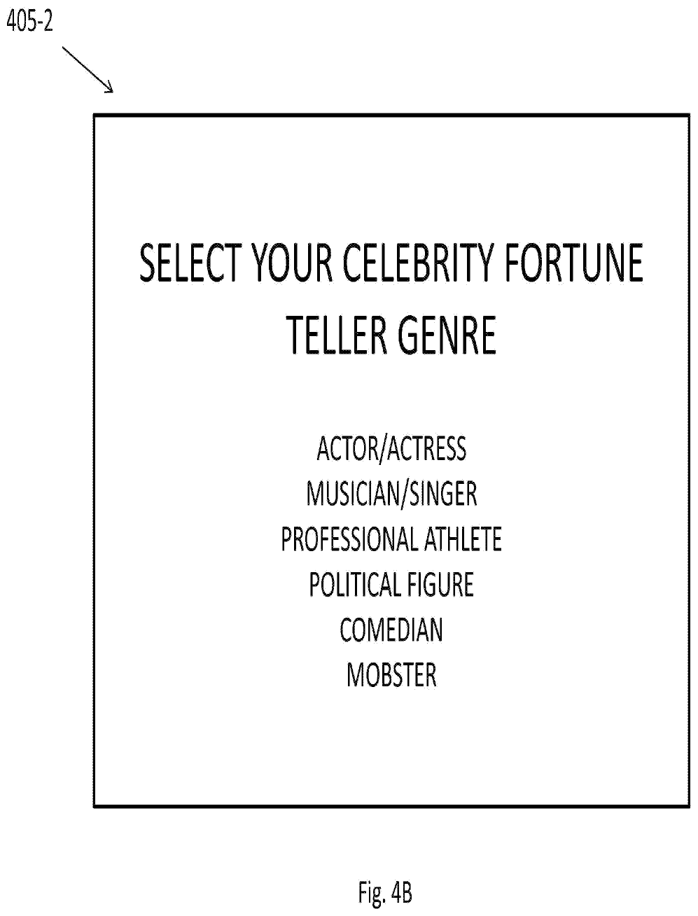

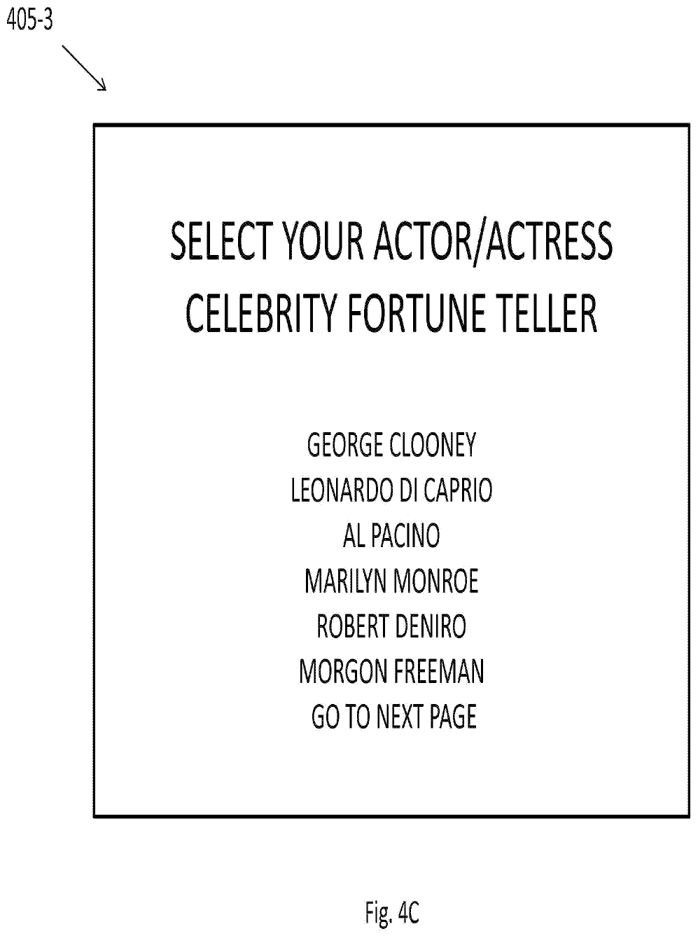

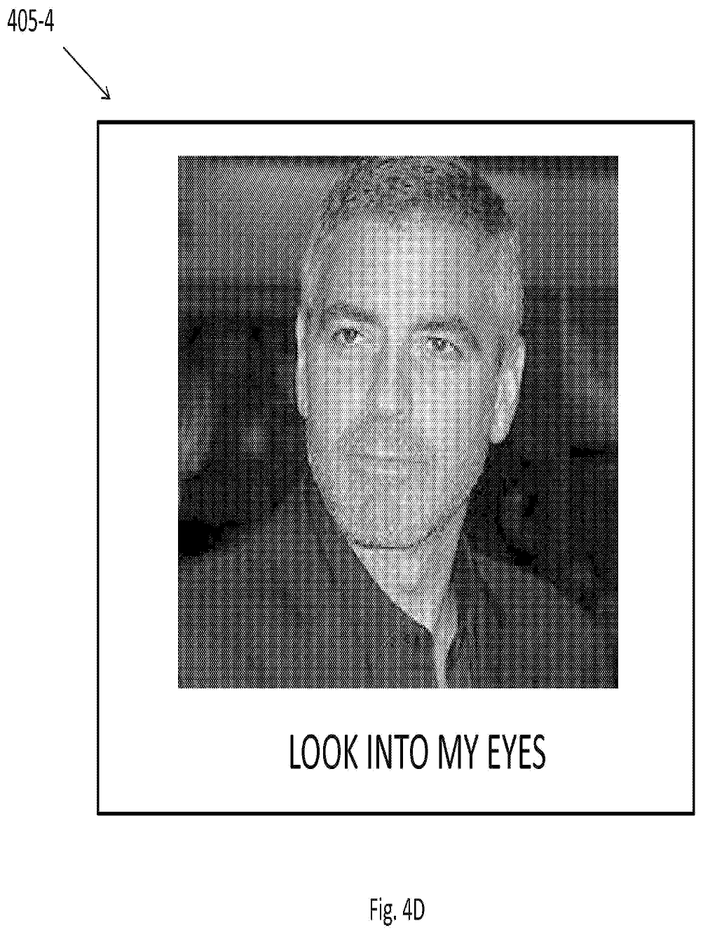

FIG. 3 show a flow chart 300 and FIGS. 4A-4D show various, exemplary screen shots 405-1 through 405-4 which together provide a detailed outline of operating the video fortune telling device 100 according to the embodiments of the present invention. At 305, a user makes a payment which is accepted by the fortune telling device 100 to have his or her fortune told by a celebrity. The payment may be made by inserting currency or coupon into the bill validator 120 or using a debit/credit card inserted into the debit/credit card reader 130. In an attract mode, the video display 110 may depict payment information as shown in screen shot 405-1 in FIG. 4A. In one embodiment, the sensor 190 (or a separate sensor) identifies movements proximate the fortune telling device 100 and enters an attract mode whereby the fortune telling device 100 displays a fortune telling routine (which may or may not use a celebrity) comprising a video and audio file intended to persuade a user to have their fortune read. For example, the attract mode fortune telling routine may comprise a video file of a traditional-appearing fortune teller which appears on video display 110 and an audio file presented over speakers 180 announcing “Come Over and Have Your Fortune Read by a Celebrity, No Time Like the Present to Learn Your Future.”

Upon receiving payment, at 310, the video display 110 presents a celebrity fortune telling genre selection as shown in screen shot 405-2 of FIG. 4B. The genres, as shown, include, but are not limited to, actor/actress, musician/singer, professional athlete, political figure, comedian and mobster. The user may select the desired genre using the touch screen or other available user interface 140. Upon receiving a genre selection, at 315, the video display 110 presents a list of celebrities included within the selected genre as shown in screen shot 405-3 of FIG. 4C. Upon receiving a celebrity selection, at 320, video and audio files associated with the selected celebrity are identified from the one or more databases 180-1 through 180-N. At 325, one of the video files and corresponding audio file associated with the selected celebrity is either randomly or chronologically selected. At 330, the randomly or chronologically selected video file and corresponding audio file is played over the video display 110 and speakers 180, respectively. Screen shot 405-4 of FIG. 4D shows an exemplary celebrity fortune teller and accompanying instructions. At 335, a souvenir memorandum of the fortune is printed by printer 135. The memorandum may include a summary of the told fortune commensurate with the fortune telling routine. In one embodiment, the printed memorandum may include a photo of the celebrity fortune teller to render the printed memorandum a keepsake.

In one specific example, the user picks Harry Houdini to read his or her fortune followed by a three stage fortune telling routine comprising: (i) an opening stage comprising an announcement by Harry Houdini; (ii) a fortune telling stage comprising the reading (e.g., you will be successful, have a great life, you will be successful in some new venture, but cautions you to watch out for strangers, etc.); and (iii) a closing stage comprising standard closing remarks and a promo for other celebrities and/or features (e.g., mock weddings) associated with the fortune telling device.

For living celebrities, the fortune telling routines may be pre-scripted and acted out by the subject celebrities. For celebrities having passed away, the fortune telling routines may be created using existing video footage and audio recording or celebrity impersonators may be used alone or in combination with the existing video footage and audio recordings. Celebrity impersonators may also be used in place of, or in combination with, living celebrities. Computer-generated imagery may also be used to create the celebrity personalities. In lieu of video footage, static images may be used as is with audio files played in the background or technology may be used to provide the static images with moving lips in sync with audio. For example, Martin Luther King's famous words “We shall overcome” can be used as a part of his fortune telling routine such that an audio file associated with a celebrity impersonator, computer-generated imagery or static image of MLK may play the following statement via speakers 180: “You shall overcome all of the obstacles in life to succeed.”

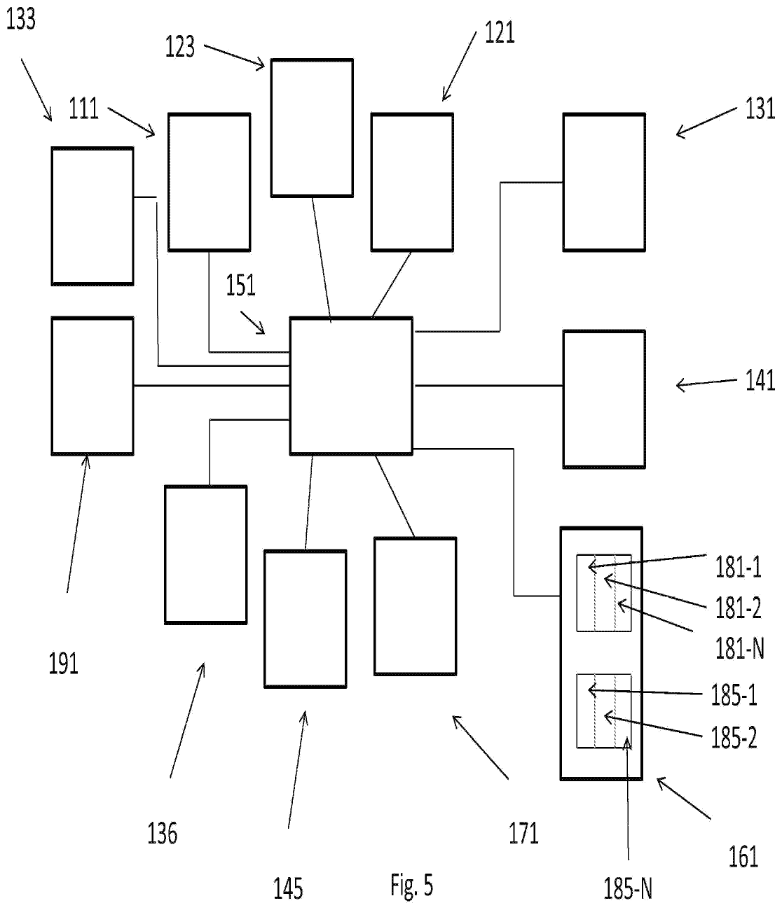

In another embodiment, a fortune telling device 101 is used as a mock wedding chapel. In this embodiment, besides performing fortune telling functions, the fortune telling device 101 is configured to utilize a celebrity to perform a fictitious wedding of a couple. FIG. 5 shows a block diagram the fortune telling device 101 according to the embodiments of the present invention. The fortune telling device 101 includes a video display 111, bill validator 121, debit/credit card reader 131, printer 136, user interface 141, processor 151, memory 161 and speakers 171. In one embodiment, the user interface 141 is a touch screen video display while in other embodiments the user interface may be a button panel, joystick, track ball or similar article. The memory 161 manages one or more databases 181-1 through 181-N directed to fortune telling routines and one or more databases 185-1 through 185-N directed to mock wedding routines.

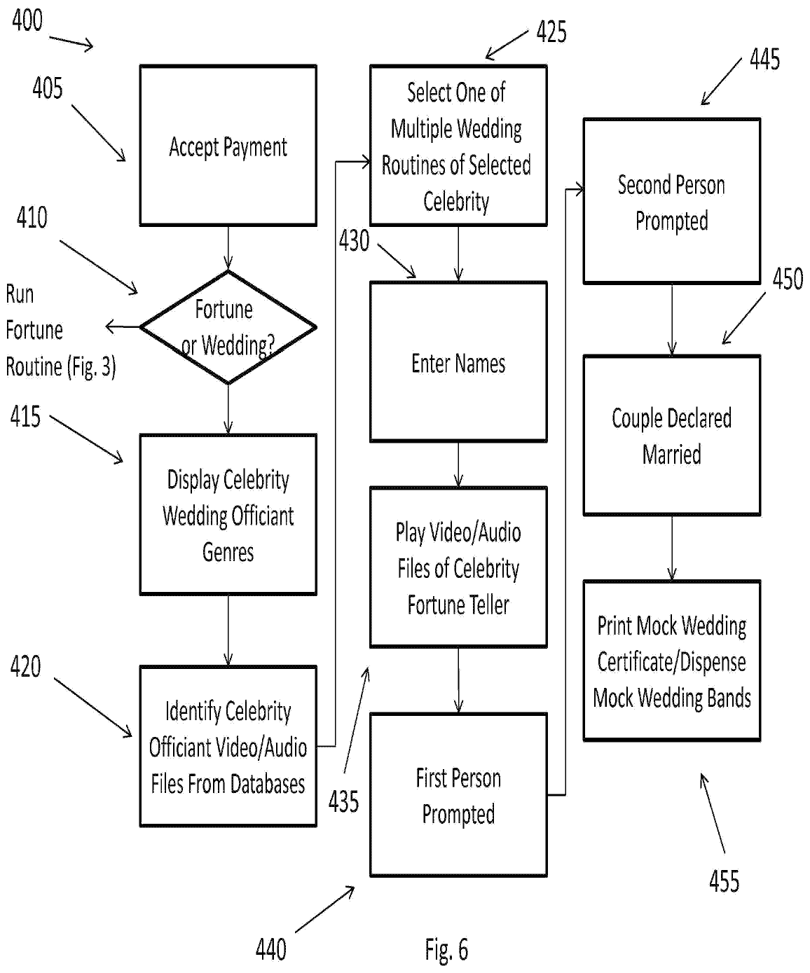

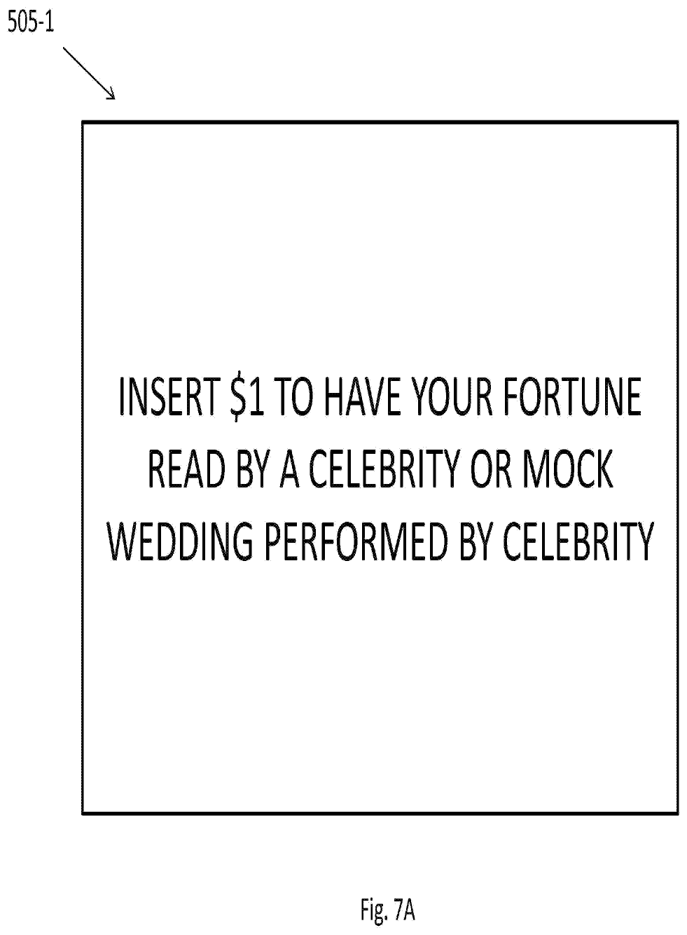

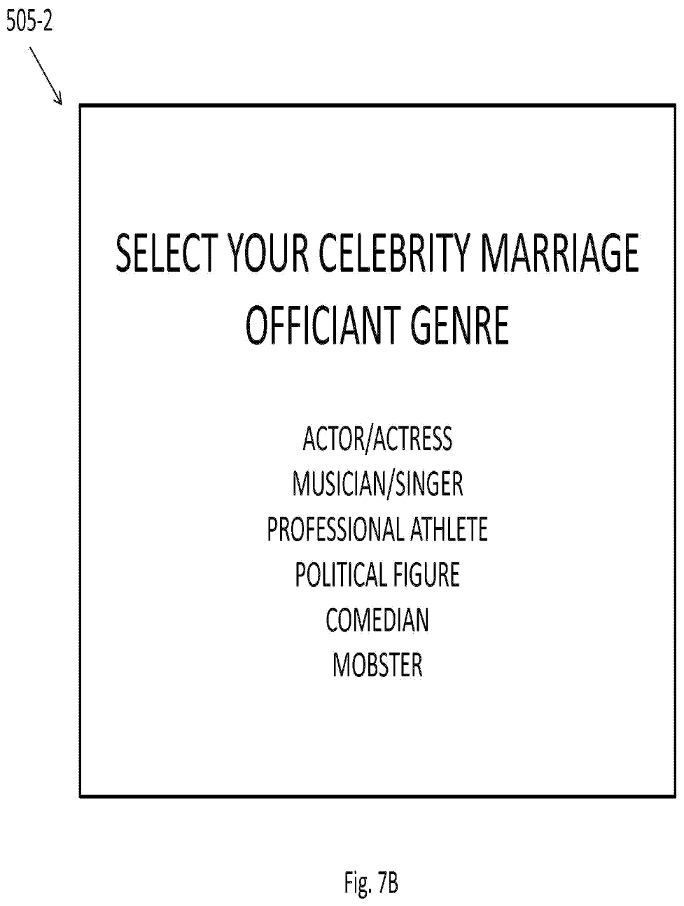

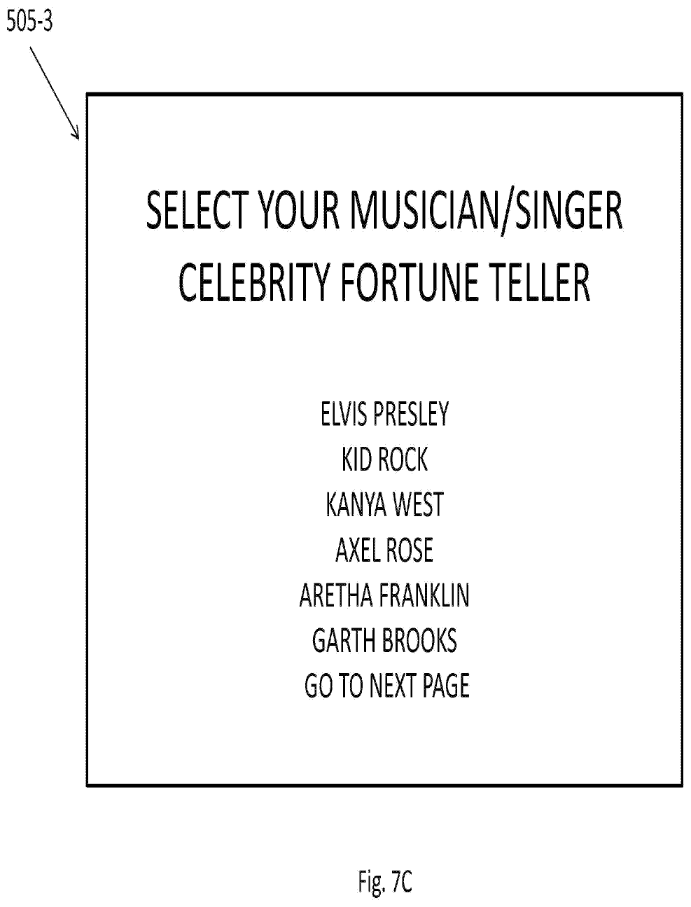

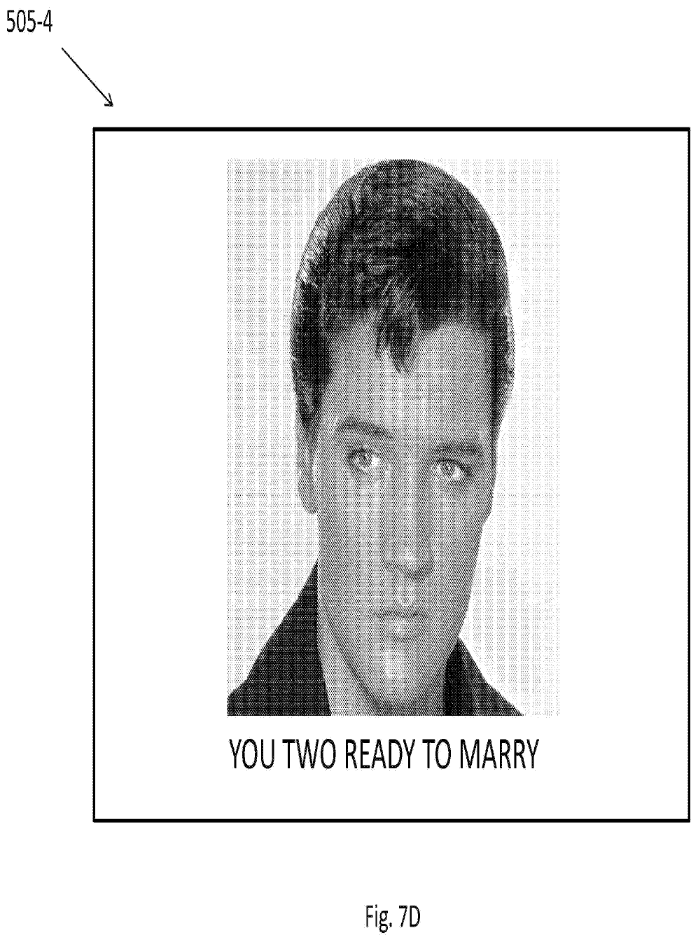

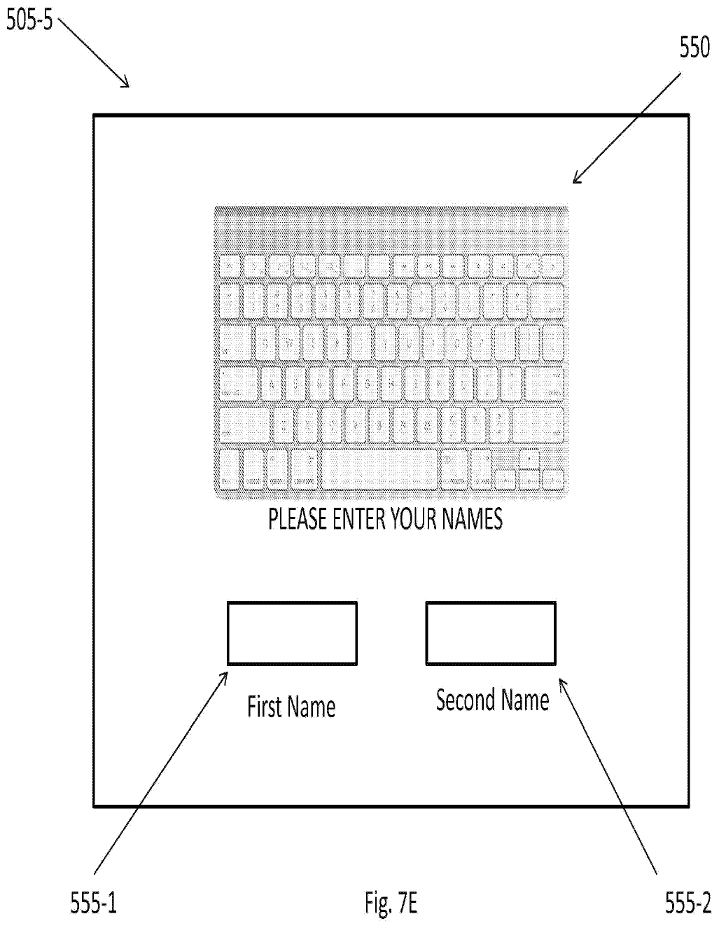

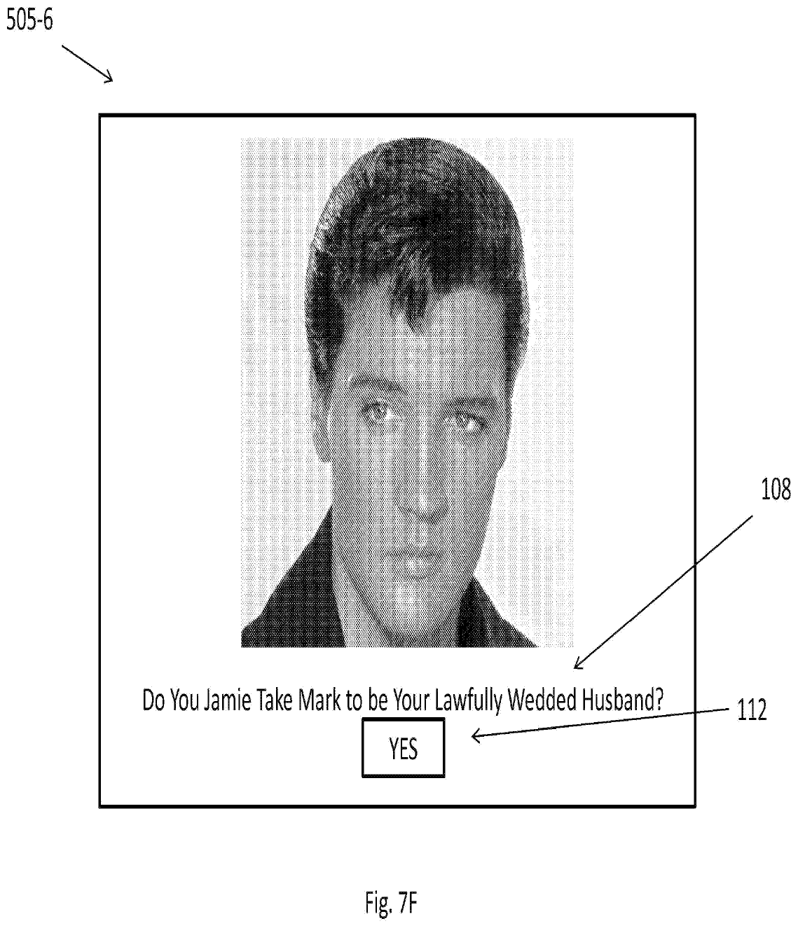

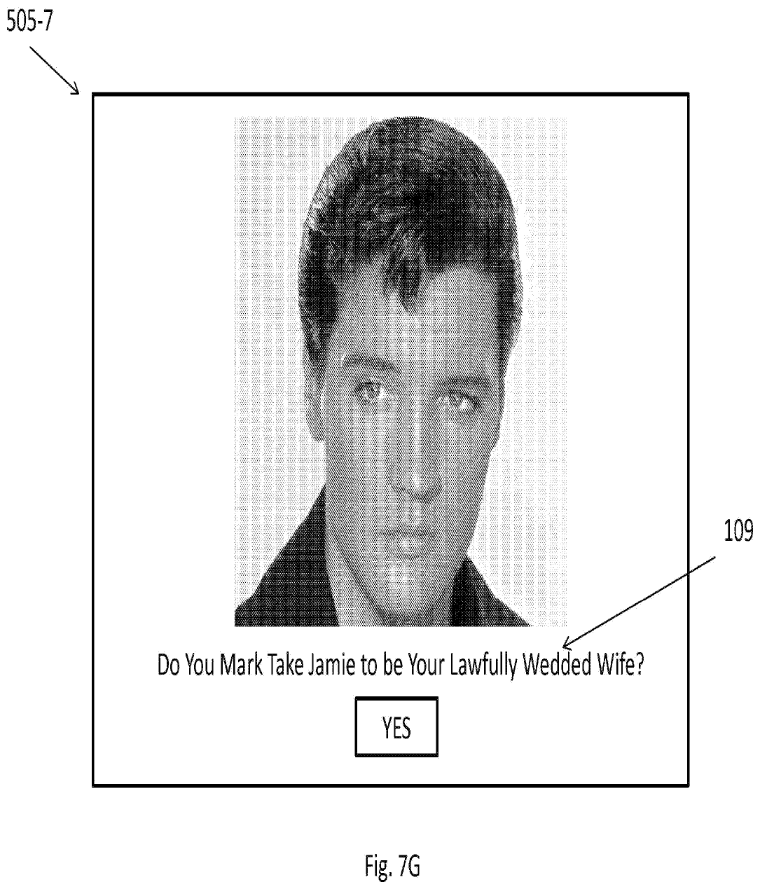

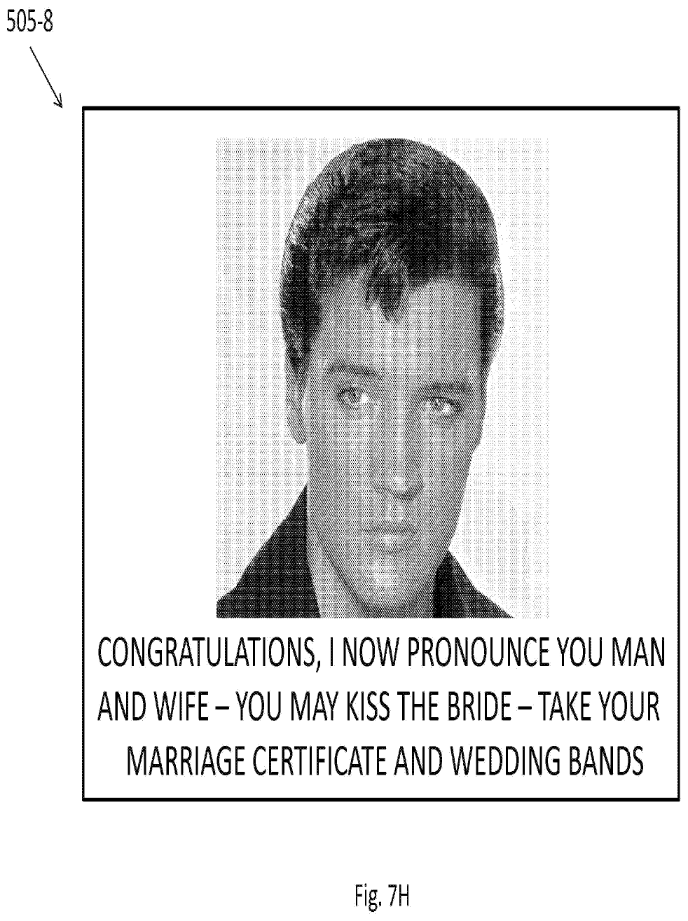

FIG. 6 shows a flow chart 400 and FIGS. 7A-7D show various, exemplary screen shots 505-1 through 505-4 which together provide a detailed outline of operating the video fortune telling device 101 as a mock wedding chapel according to the embodiments of the present invention. At 405, a user makes a payment accepted by a fortune telling device 100 to have his or her fortune told by a celebrity or a mock wedding performed by a celebrity. The payment may be made by inserting currency or coupon into the bill validator 121 or using a debit/credit card inserted into the debit/credit card reader 131. In an attract mode, the video display 111 may depict payment information as shown in screen shot 505-1 in FIG. 5A. In one embodiment, the sensor 191 (or a separate sensor) identifies movements proximate the fortune telling device 101 and enters an attract mode whereby the fortune telling device 101 displays a fortune telling routine or mock wedding routine (which may or may not use a celebrity) comprising a video and audio file intended to persuade a user to have their fortune read. For example, the attract mode mock wedding routine may comprise a video file of a celebrity wedding officiant appearing on video display 111 and an audio file presented over speakers 181 announcing “Come Over and Marry Your Sweetheart—No Waiting.”

Upon receiving payment, at 410, the video display 111 presents a user with a celebrity fortune telling or mock wedding option. If the user selects the celebrity fortune telling option, flowchart 300 is followed. If the user selects mock wedding option, at 415, a celebrity wedding officiant genre selection is presented as shown in screen shot 505-2 of FIG. 5B. The genres, as shown, include, but are not limited to, actor/actress, musician/singer, professional athlete, political figure, comedian and mobster. The user may select the desired genre using the touch screen or other available user interface 141. Upon receiving a genre selection, at 420, the video display 111 presents a list of celebrities included within the selected genre as shown in screen shot 505-3 of FIG. 5C. Upon receiving a celebrity selection, at 420, video and audio files associated with the selected celebrity are identified from the one or more databases 181-1 through 181-N. At 425, one of the video and corresponding audio files is selected randomly or chronologically and the selected celebrity is presented on the video display 111, as shown in screen shot 505-4 of FIG. 5D, with an introductory message (e.g., You Two Ready to Marry). At 430, the user is prompted to enter the names of the persons to be fictitiously married. As shown in screen shot 505-5 of FIG. 5E, the video display 111 displays an interactive keyboard 550 allowing the user to enter the two names of the persons to be married in input boxes 555-1, 555-2 via the touch screen interface 141. At 435, the randomly or chronologically selected video file and corresponding audio file is played over the video display 111 and speakers 171, respectively. At 440, a first person being fictitiously married is asked to confirm his or her desire to many. For example, an audio file may be played via speakers 171 announcing “Do you Jamie take Mark to be your lawfully wedded Husband?” and/or it may be presented, as shown in screen shot 505-6 of FIG. 5F, on video display 111 in the form of a question 108. Voice recognition software may evaluate an audio response or a user may touch response icon 112. Once as response has been input either via the touch screen interface 141 or audio microphone 145 or no response is forthcoming within a pre-established time period (e.g., 10 seconds), the flow chart 400 advances. At 445, a second person being fictitiously married is asked to confirm his or her desire to marry. For example, an audio file may be played via speakers 171 announcing “Do you Jamie take Mark to be your lawfully wedded Husband?” and/or it may be presented, as shown in screen shot 505-7 of FIG. 5G, on video display 111 in the form of a question 109. At 450, once a response has been input either via the touch screen interface 141 or audio microphone 145 or no response is forthcoming within a pre-established time period (e.g., 10 seconds), the flow chart 400 advances. At 455, the fortune telling device 101 declares the couple married and printer 137 prints a fictitious keepsake marriage certificate dispensed via a printer slot. Screen shot 505-8 of FIG. 7H shows a message 114 regarding the same.

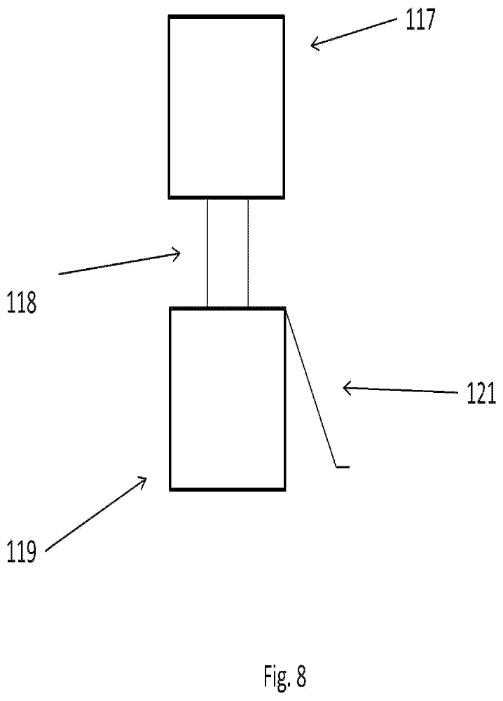

In one embodiment, as shown in FIG. 8, a pair of inexpensive, mock wedding bands is dispensed from a storage compartment 117 via a chute 118 into an accessible compartment 119 from which the user may lift a door 121 and collect the dispensed mock, wedding bands. The mock wedding bands may be contained in a sealed bag. The sealed bags of wedding bands may be maintained by a motorized carousal or other mechanical device controlled by the processor 151.

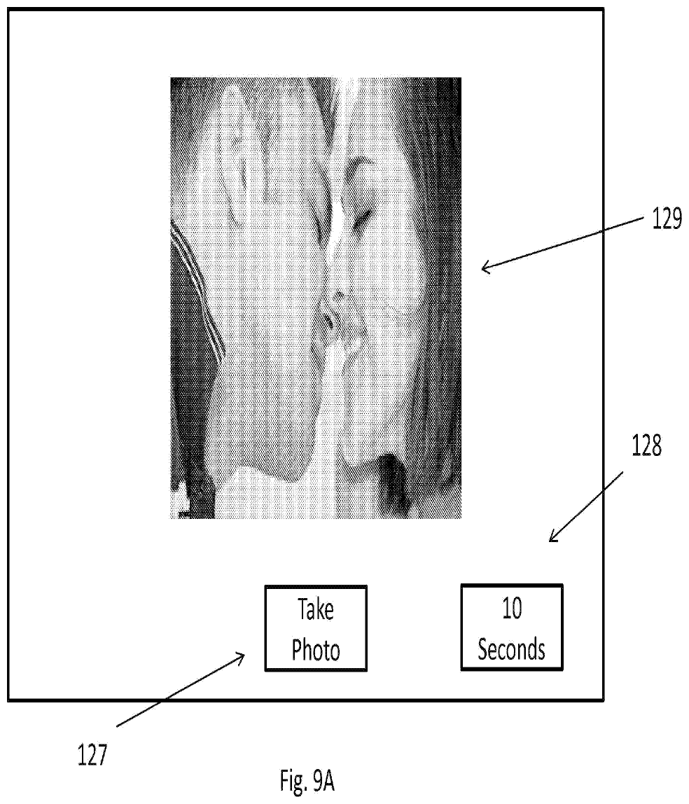

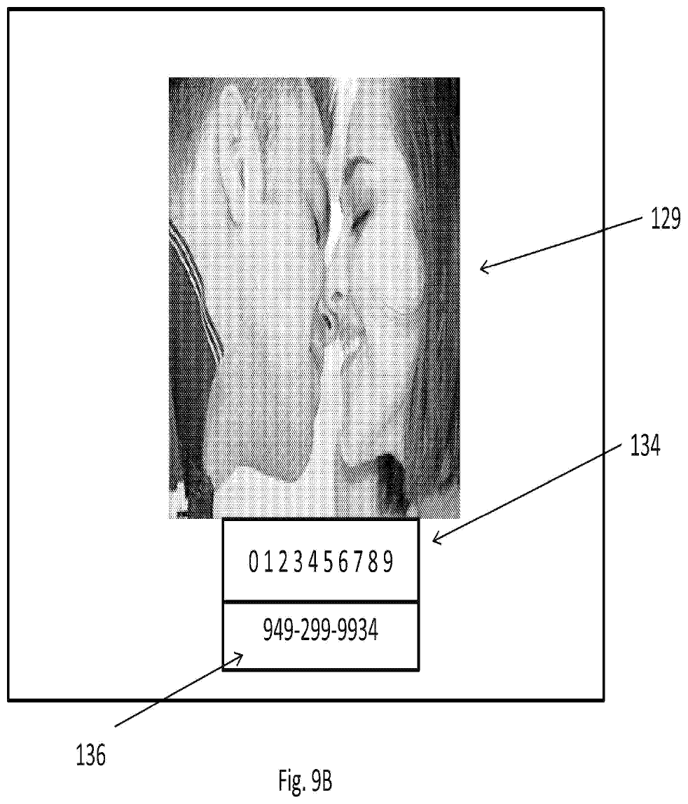

In one embodiment, the fortune telling device 101 includes a camera 123 which is configured to take a photo of the wedding couple which can be wirelessly transmitted to a mobile device of the user. Taking the photo may be triggered by a photo icon 127 as shown in FIG. 9A. A timer 128 allows the couple to arrange themselves for the photo and window 129 allows the couple to confirm they are in the correct location for the photo. A transmitter 133 is configured to send the photo a mobile device as identified by the user via touch screen number grid 134 and window 136 as shown in FIG. 9B.

Like above relative to fortune telling routines, the celebrity wedding routines may be created using living celebrities, celebrity personalities, computer-generated imagery and/or static images.

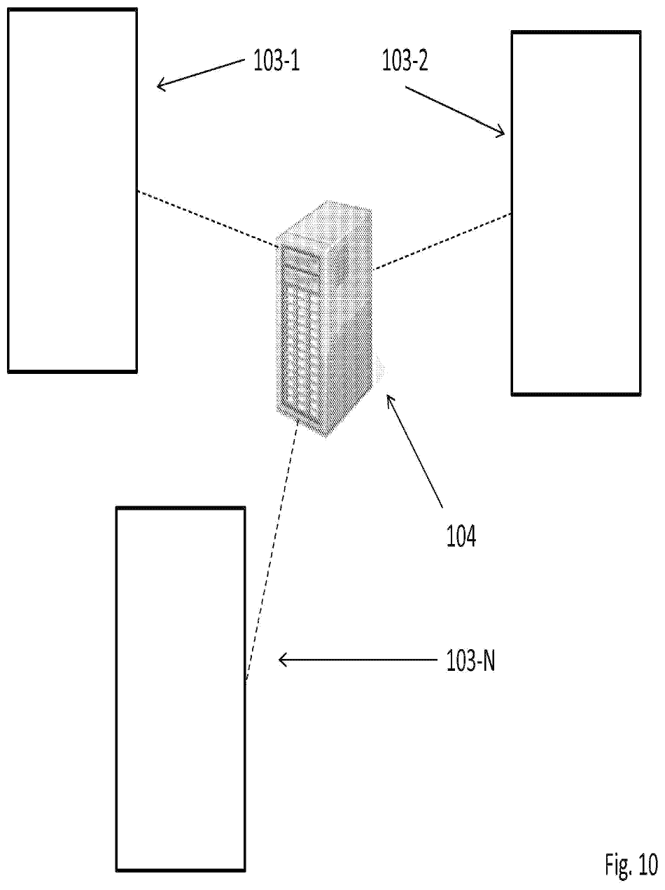

While the fortune telling devices 100, 101 are described above with video and audio files stored locally, in another embodiment, as shown in FIG. 10, the video and audio files may be stored remotely on, for example, one or more central computers or servers 104 accessible via an Internet-style connection. In such an embodiment, multiple fortune telling devices 103-1 through 103-N may be linked to the server 104 creating a network from which all fortune telling devices 103-1 through 103-N may access video and audio files from the central server 103 which are then transmitted via cables/wires or wirelessly to the subject fortune telling device 103-1 through 103-N for play. Processing power may be at the server 104, gaming devices 103-1 through 103-N or a combination thereof.

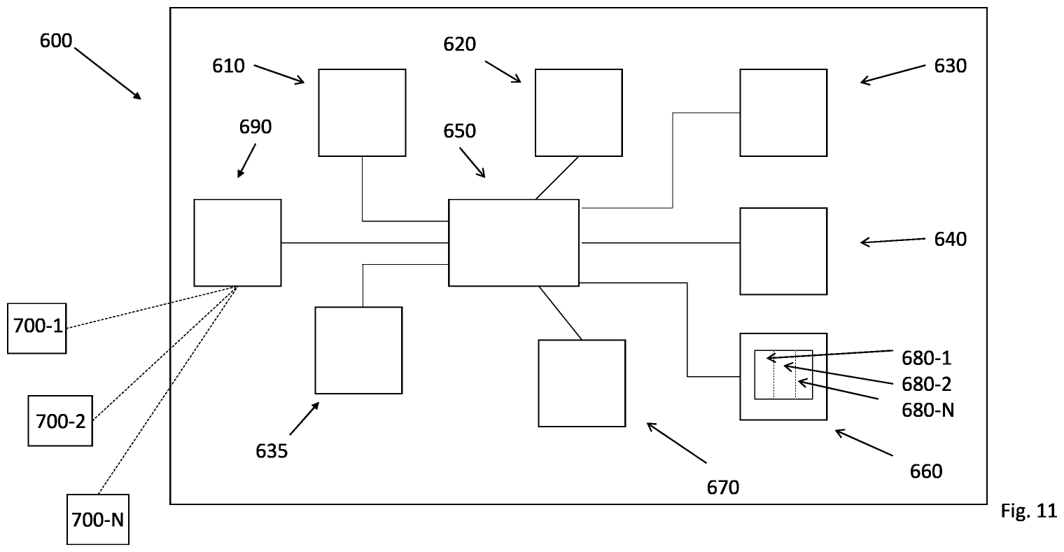

FIG. 11 illustrates a block diagram of another embodiment of a fortune telling device 600 further equipped with touting services according to the embodiments of the present invention. Touting services as set forth herein comprise predictions on the outcomes of future events such as sporting events and elections. The fortune telling device 600 includes a video display 610, bill validator 620, debit/credit card reader 630, printer 635, user interface 640, processor 650, memory 660 and speakers 670. The memory 660 may manage one or more databases 680-1 through 680-N. A wired or wireless receiver 690 is configured to receive touting information from one or more remote sources 700-1 through 700-N. The receiver 690 may be any piece of hardware and/or software configured to receive the touting information. In one embodiment, the receiver 690 may be integrated into other components (e.g., the processor 650). In one embodiment, the remote sources 700-1 through 700-N are independently operated tout services (e.g., Jim Feist Sports out of Las Vegas, Nev.). Such independent tout services charge customers a fee for providing predictions on future sporting events which customers then use to place wagers on said future sporting events. Currently, sports books in Nevada are the lone entities legally permitted to accept sports wagers within the United States. However, many non-US jurisdictions have legalized sports betting.

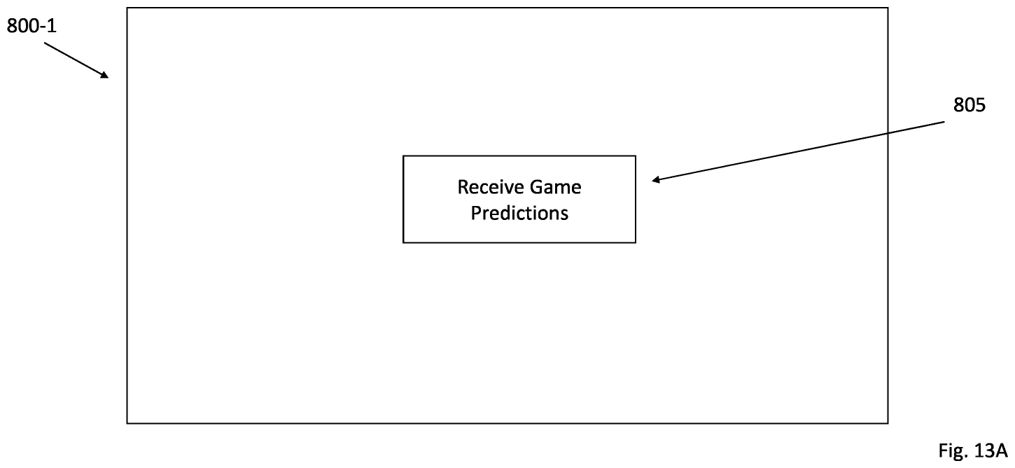

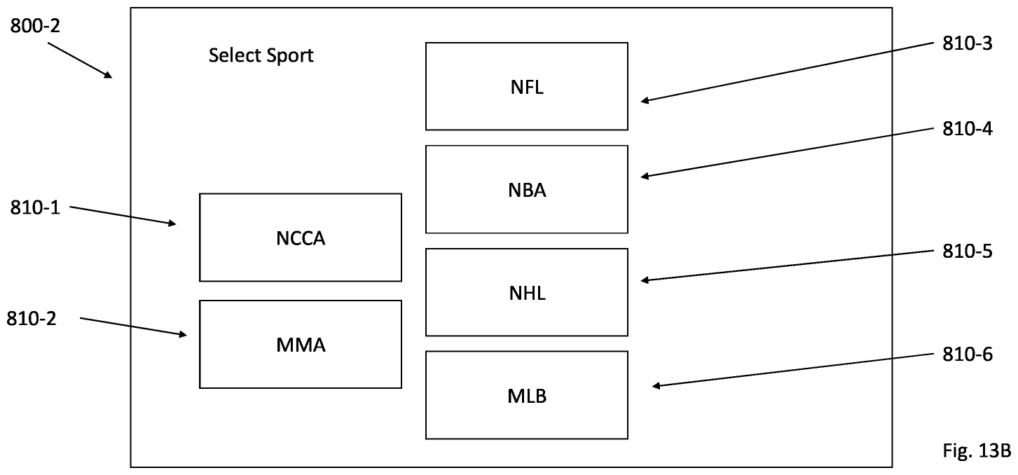

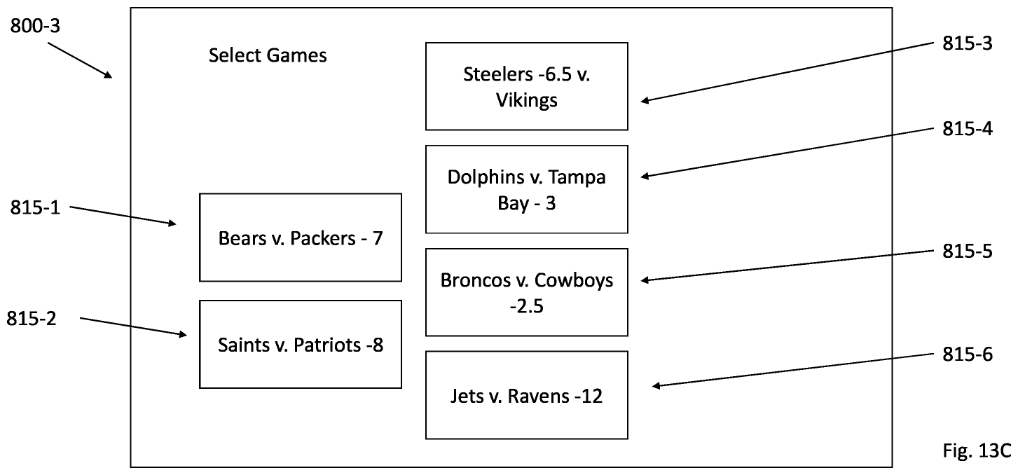

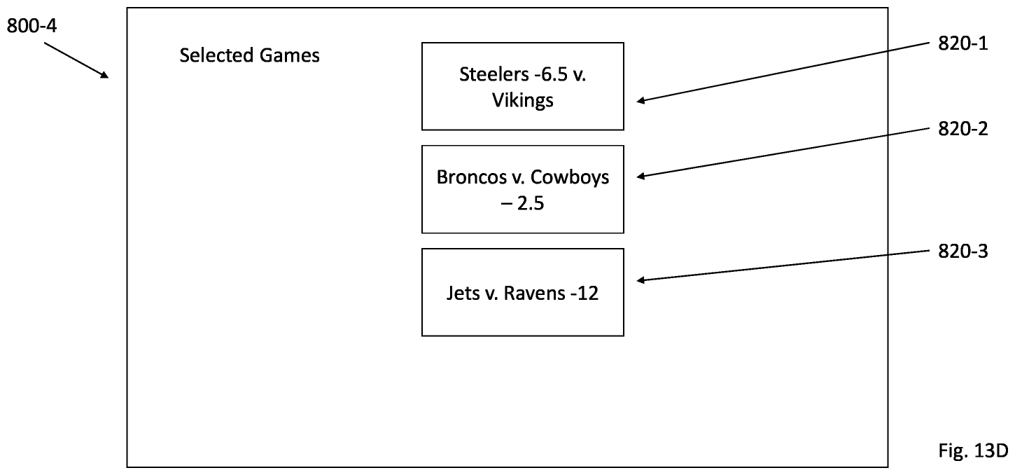

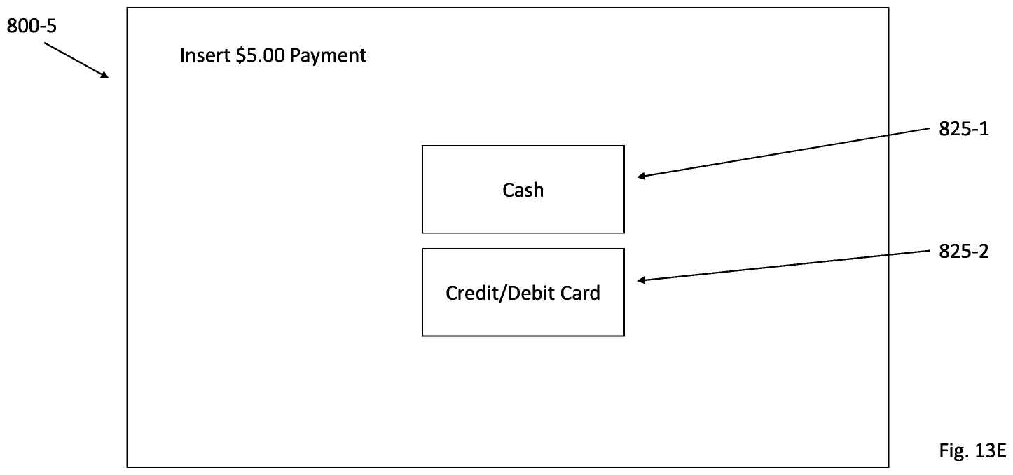

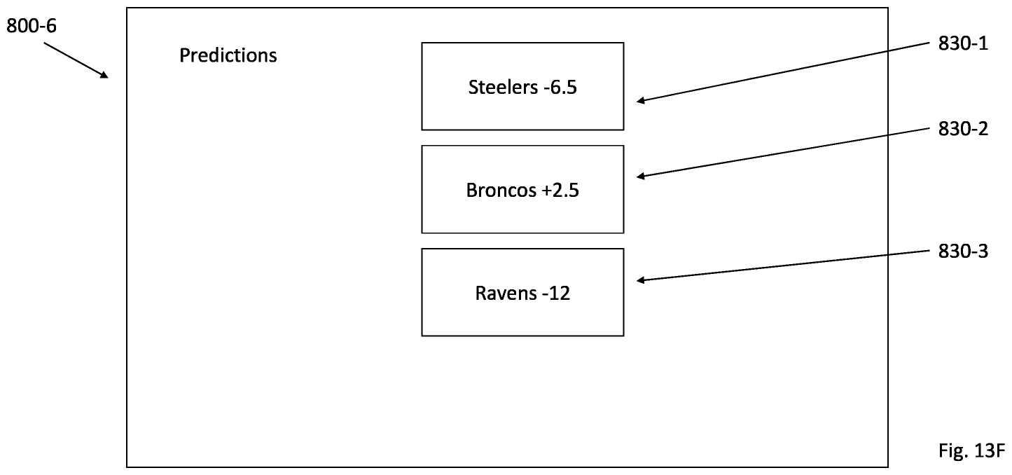

In one embodiment, the fortune telling device 600 acts as an intermediary between the independent tout services and customer. In this embodiment, users have the option, via the user interface (e.g., touch screen display) to receive tout services for a fee. FIG. 13A shows an exemplary screen shot 800-1 through which users may activate the tout service via icon 805. FIG. 13B shows a screen shot 800-2 depicting a tout service page displayed responsive to utilizing the icon 805. On page 800-2, the user selects one or more sports 810-1 through 810-6 on which the user wants predictions. On screen shot 800-3, shown in FIG. 13C, a list of games 815-1 through 815-6 with spreads for the selected sport (NFL in this instance) is displayed. The list of games 815-1 through 815-6 and spreads may be received from and updated by the remote tout services 700-1 through 700-N or via a separate remote source(s). FIG. 13D shows screen shot 800-4 depicting selected games 820-1 through 820-3. FIG. 13E shows screen shot 800-5 offering cash 825-1 and credit/debit card payment 825-2 for the $5 fee. The fee is established by the operator of the fortune telling device 600 and may be related in some manner to the fees, if any, paid by the operator to the independent touting services 700-1 through 700-N. FIG. 13F shows screen shot 800-6 depicting predictions 825-1 through 825-3 for selected games 820-1 through 820-3. The fortune telling device 600 prints a ticket memorializing the predictions 825-1 through 825-3.

In another embodiment, the fortune telling device 600 randomly selects the games on which to formulate predictions. In such an embodiment, the user simply pays the established fee and selects a sport or sports after which the fortune telling device 600 prints a ticket with one or more predictions based on the independent tout services 700-1 through 700-N. In another embodiment, the user does not select the sport as the fortune telling device 600 randomly selects the sports and games. In another embodiment, the fortune telling device 600 randomly predicts game outcomes (i.e., there is no link to independent tout services 700-1 through 700-N). In this embodiment, the fortune telling device 600 receives schedule and spread information from third party sources.

In another embodiment, the fortune telling device 600 is configured to analyze the touting information and determine the best two or three predictions. For example, if the fortune telling device 600 subscribes to ten touting services, the fortune telling device 600, via the processor and/or software, determines which teams are most liked by the touting services and provides those teams as its predictions for the day or week. If, for example, nine of the ten touting services like the New England Patriots to cover the 6-point spread against the New Orleans Saints, the fortune telling device 600 includes the Patriots as one of its predictions.

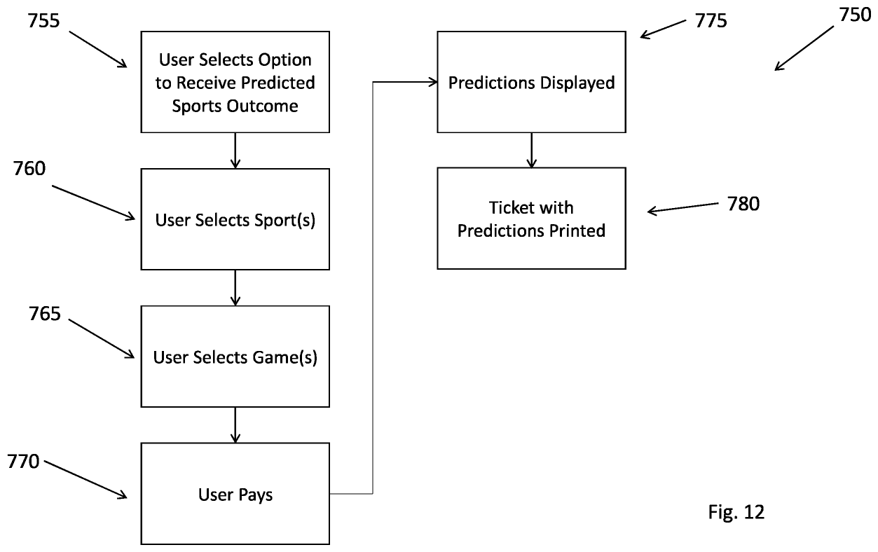

FIG. 12 illustrates a flow chart 750 detailing a method of operating the fortune telling device 600 equipped with the touting services according to the embodiments of the present invention. At 755, the user selects, via user interface 640, the option to view available sports from which to seek predictions. At 760, the user selects the sport(s). At 765, the user selects game(s). At 770, the user pays for the selected games. At 775, the predictions are presented on a display of the fortune telling device 600. In one embodiment, the predictions are based on the touting information received from the remote sources. In one embodiment, if multiple remote touting services are utilized, the game predictions are based on the majority of like predictions by the multiple remote touting services. For example, if the user selects the Steelers −6.5 v. Vikings game and two of three remote tout services like the Steelers to cover the 6.5 points, the fortune telling device 600 predicts the Steelers −6.5. If only a single tout service is utilized, the predictions may be based on the single tout service. At 770, a ticket with the predictions is printed.

While not shown, the fortune telling device 600 may provide audible commentary, via speakers 670, regarding the predictions. For example, the fortune telling device 600 may transmit via the speakers a statement that “I love the Steelers to cover the six and one-half point spread against the Vikings.” Such partially prepared statements may be maintained in databases 680-1 through 680-N. For example, the stored statement may be “I love the ______ to cover the ______ point spread against the ______” wherein the blanks are filled in based on the selected game and prediction.

The link to the touting services 700-1 through 700-N may be used to update the game spreads/odds in real-time, hourly, or in any intermittent time period desired depending on the configuration of the fortune telling device 600. Thus, it is conceivable that different users may receive different predictions for the same game based on receipt of new updated information (e.g., injuries).

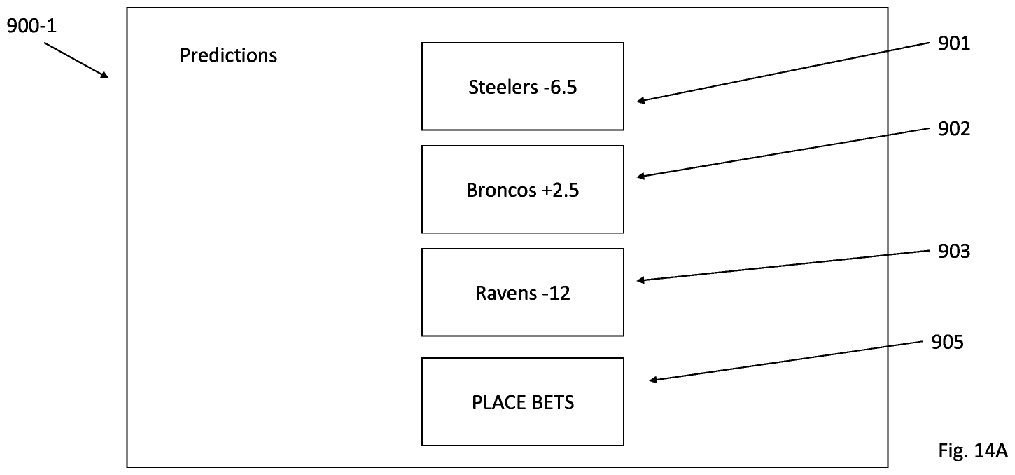

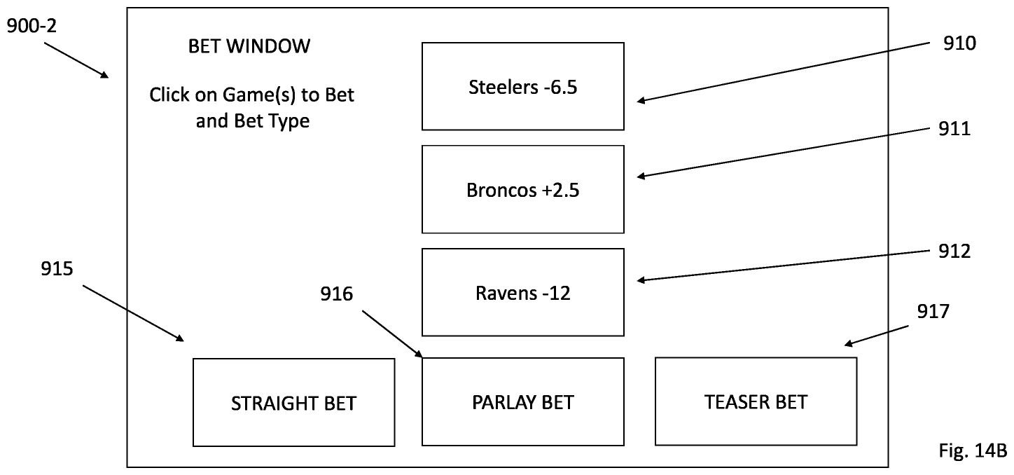

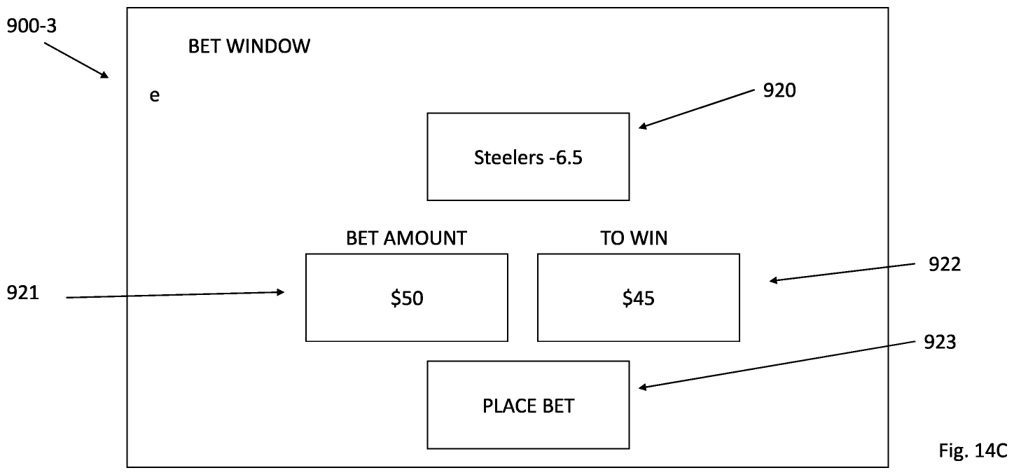

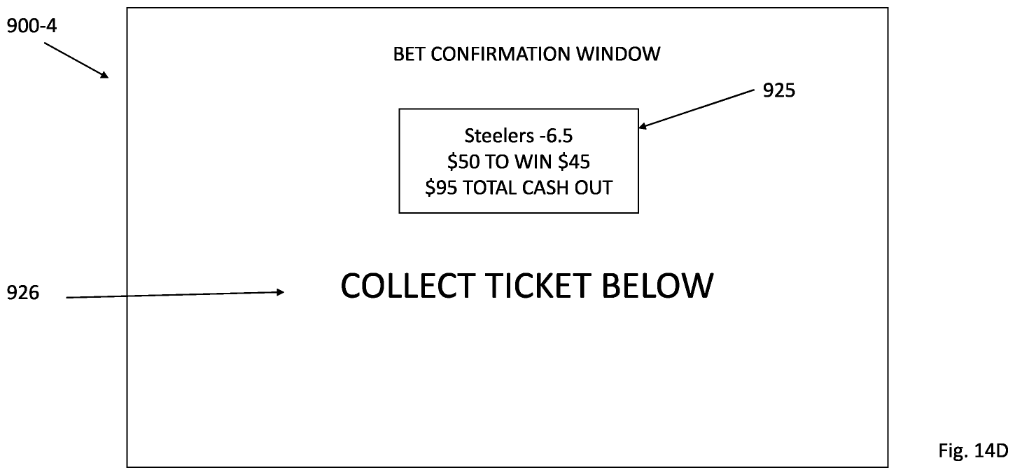

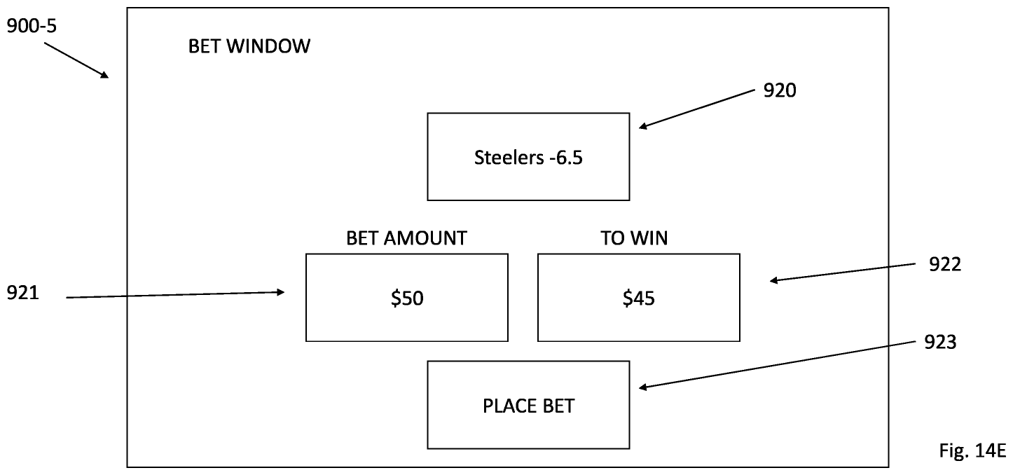

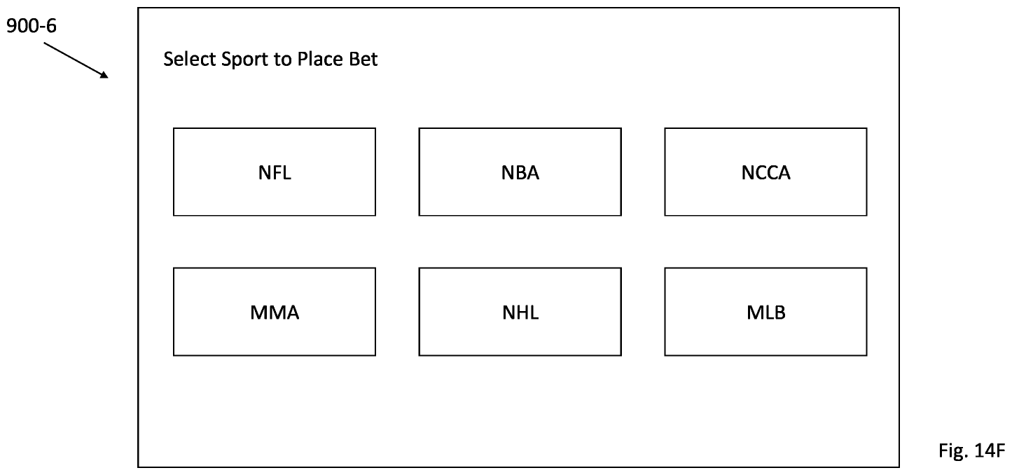

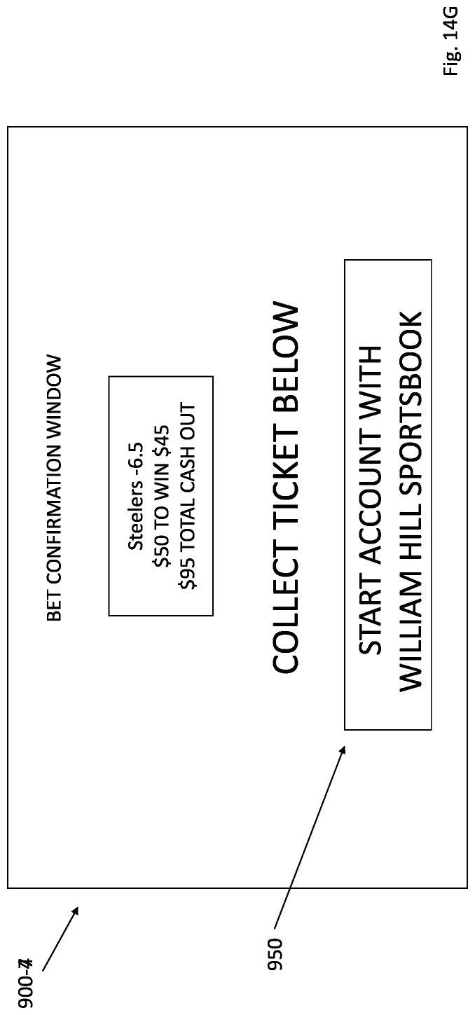

In another embodiment, the fortune telling device 600 may also act as an intermediary for users to place sports bets on the predictions provided by the device. Now referring to FIGS. 14A through 14F, the fortune telling device 600 includes a user interface, via which, users may place sports bets. In this embodiment, the fortune telling device 600 communicates directly with a betting server operated by a legally licensed sports betting entity. Consequently, the fortune telling device 600 may be used to place bets through a legal sports betting outlet (e.g., sportsbook located in Las Vegas, Nev.). Sportsbooks, like William Hill, are licensed to accept bets on the outcomes of sporting events. Given the fixed nature of the fortune telling device 600, it is a simple matter to ensure that the user is in a jurisdiction that permits sports betting. That is, the very fact that the fortune telling device 600 is in communication with a legally licensed sports betting entity authenticates the location of the user.

FIG. 14A shows screen shot 900-1 depicting predictions 901, 902 and 903 and a “PLACE BETS” icon 905. Upon clicking on the PLACE BETS icon 905, a user is advanced to a bet window depicted as screen shot 900-2 in FIG. 14B. The bet window includes a STRAIGHT BET icon 916, PARLAY BET icon 917 and TEASER BET icon 918 for users to select the desired bet type. Those skilled in the art will recognize that other bet type icons may be provided. FIG. 14C shows screen shot 900-3 once the user has selected to make a straight bet on the Steeler at −6.5 points (i.e., Steelers need to win by 7 to win the bet). FIG. 14D shows screen shot 900-4 depicting a Bet Confirmation window showing the placed bet 920 and a notice 921 to collect the printed sports bet ticket. The sports bet tickets may be printed with associated redeemable cash value attached as well. FIG. 14G shows an alternative screen shot 900-7 depicting a Bet Confirmation window and a start account link 950 for players to sign-up with a sports bet provider.

FIG. 14E shows screen shot 900-5 depicting a home screen 930 via which the user may select various device functions. As shown, the functions include a FORTUNE icon 931, GAME PREDICTION icon 932, BET icon 933, CHECK TICKET icon 934 and CASH TICKET icon 935. Using the BET icon 933, the user is advanced to a page allowing the user to bet any games, not only those selected by the fortune telling device 600. FIG. 14F shows a home screen 900-6 depicting different sports the user may place bets. The CHECK TICKET icon 934 and CASH TICKET icon 935 allow users to check whether a sports bet ticket is a winner and cash winning sports bet tickets, respectively. Cashing the sport bet ticket may comprise the fortune telling device 600 dispending cash or a voucher which may be cashed at a cashier or sports book terminal.

In one embodiment, any new customer placing a bet via the fortune telling device 600 linked to a third-party sportsbook (i.e., the fortune telling device 600 is not owned and operated by the sportsbook) provides means for identifying where the bet was placed. In this manner, the sportsbook may compensate the non-sportsbook operator of the fortune telling device 600. In this instance, the fortune telling device 600 may also prompt the user to start an account with the sportsbook operator (server) to which the fortune telling device 600 is linked. FIG. 14G shows an exemplary screen 900-7 with START ACCOUNT icon 950 prompting a user, having placed a bet, to register for an account with the sportsbook handling the bet. Players signing up for an account may also prompt compensation from the sportsbook operator to the non-sportsbook operator of the fortune telling device 600. In another embodiment, the user may be permitted to select a sportsbook from a plurality of linked sport books through which to make bets and/or start an account.

The fortune telling device 600 with the touting and betting applications may be placed in any number of locations including casinos, bars, lounges and sports books and may be integrated into a kiosk, gaming device or be configured as a standalone device.

Although the invention has been described in detail with reference to several embodiments, additional variations and modifications exist within the scope and spirit of the invention as described and defined in the following claims.

I claim:

1. A fortune telling device, comprising:
a housing containing at least a display, user interface, speakers, printer, memory, receiver and processor, said receiver configured to receive touting information from one or more remote touting sources;
wherein said processor is configured to: (i) present visual files on said display and corresponding audio files over said speakers, said visual and audio files related to one or more fortune telling services, said fortune telling services including predicted outcomes on sporting events based on said touting information received from said one or more remote touting sources; and
wherein said processor is further configured to: provide an interface for a user to place a sports bet, via a linked sportsbook server, on said one or more predicted outcomes on said sporting events.

2. The fortune telling device of claim 1 wherein said processor is further configured to: present on said video display sporting events from which users may select to receive predicted outcomes.

3. The fortune telling device of claim 1 wherein said predicted outcomes on said sporting events correspond to a majority of common predicted outcomes on said sporting events from said one or more remote touting sources.

4. The fortune telling device of claim 1 wherein said processor is further configured to: cause said printer to print a sports bet ticket based on a bet placed by a user.

5. The fortune telling device of claim 1 wherein said processor is further configured to: allow a user to register for a sports betting account with a third-party sportsbook.

6. The fortune telling device of claim 1 wherein said processor is further configured to: allow a user to check a sports bet ticket as a winner or loser and cash out a winning sports bet ticket.

7. A fortune telling device, comprising:
a housing containing at least a video display, user interface, speakers, printer, memory, receiver and processor, said receiver configured to receive touting information from one or more remote touting sources;
wherein said processor is configured to: (i) present a list of sporting events from which a user may seek sporting event outcome predictions; (ii) accept, via said user interface, select sporting event selections by said user; (iii) accept user payment for said sporting event selections by said user and (iv) present sporting event outcome predictions associated with said sporting event selections of said user, said sporting event outcome predictions related to said touting information received from said one or more remote touting sources; and
wherein said processor is further configured to: provide an interface for a user to place a sports bet, via a sportsbook, on said one or more predicted outcome on sporting events.

8. The fortune telling device of claim 7 said sporting event outcome predictions correspond to a majority of common sporting event outcome predictions from said one or more remote touting sources.

9. The fortune telling device of claim 7 wherein said processor is further configured to: cause said printer to print a sports bet ticket responsive to a user making a bet.

10. The fortune telling device of claim 7 wherein said processor is further configured to: allow a user to register for a sports betting account with a third-party sportsbook.

11. The fortune telling device of claim 7 wherein said processor is further configured to: allow a user to check a sports bet ticket as a winner or loser and cash out a winning sports bet ticket.

12. A fortune telling device, comprising:
a housing containing at least a video display, user interface, speakers, printer, memory, receiver and processor, said processor and receiver in communication with one or more remote touting sources and one or more sportsbooks;
wherein said processor is configured to: (i) present a list of sporting events from which a user may seek sporting event outcome predictions; (ii) accept, via said user interface, select sporting event selections by said user; (iii) present sporting event outcome predictions associated with said sporting event selections of said user, said sporting event outcome predictions related to said touting information received from said one or more remote touting sources; and (iv) accept, via said user interface, bets on select sporting events having predicted outcomes associated therewith.

13. The fortune telling device of claim 12 said sporting event outcome predictions correspond to a majority of common sporting event outcome predictions from said one or more remote touting sources.

14. The fortune telling device of claim 12 wherein said processor is further configured to: cause said printer to print a sports bet ticket responsive to a user making a bet.

15. The fortune telling device of claim 12 wherein said processor is further configured to: allow a user to register for a sports betting account with a third-party sportsbook.

16. The fortune telling device of claim 12 wherein said processor is further configured to: allow a user to check a sports bet ticket as a winner or loser and cash out a winning sports bet ticket.

17. The method of claim 12 further comprising presenting said one or more event outcome predictions on said display.
